(19) United States
(12) Patent Application Publication
(10) Pub. No.: US 2024/0193670 A1
(43) Pub. Date: Jun. 13, 2024

(54) ITEM MANAGEMENT SYSTEM, METHOD, AND INFORMATION PROCESSING APPARATUS

(71) Applicant: CANON KABUSHIKI KAISHA, Tokyo (JP)

(72) Inventor: TOSHIFUMI KITAMURA, Shizuoka (JP)

(21) Appl. No.: 18/585,694

(22) Filed: Feb. 23, 2024

Related U.S. Application Data
(63) Continuation of application No. PCT/JP2022/025499, filed on Jun. 27, 2022.

(30) Foreign Application Priority Data
Sep. 3, 2021 (JP) 2021-144169

(51) Int. Cl. G06Q 30/0601

(52) U.S. Cl. CPC G06Q 30/0633

(57) ABSTRACT

An item management system includes a reading apparatus capable of reading, from a wireless device, identification information stored in the wireless device; a management unit configured to manage, in a database, a list of one or more items that are subject to a work by a user and a status of each item regarding the work; and a first wireless device attached to a first item included in the list and storing first identification information associated with the first item. The management unit updates the status of the first item when it is determined that the reading apparatus has read the first identification information from the first wireless device in a state where a first user has logged into the item management system and a first user operation representing a start of the work regarding the list has been detected.

### CROSS-REFERENCE TO RELATED APPLICATIONS

This application is a Continuation of International Patent Application No. PCT/JP2022/025499, filed Jun. 27, 2022, which claims the benefit of Japanese Patent Application No. 2021-144169, filed Sep. 3, 2021, both of which are hereby incorporated by reference herein in their entirety.

### BACKGROUND OF THE INVENTION

### Field of the Invention

The present disclosure relates to an item management system, a method, and an information processing apparatus.

### Background Art

Radio frequency identification (RFID) is a technology that allows information embedded in a small device which is also referred to as a tag to be read by an external reader through short-range wireless communication. For example, an RFID tag in which unique identification information is embedded is attached to an item so that a location of the item can be efficiently known in item stock and distribution management and that visualization of information on managed items becomes easier. Among others, a passive type RFID tag, which transmits information utilizing energy of electromagnetic wave emitted from a reader, does not require a battery, leading to low manufacturing cost and semipermanent operation. Hence, it has become widely-used not only in the stock and distribution management but also in various applications.

Patent Literature 1 discloses an example of a system which makes use of RFID tags for item stock management purpose. The system of Patent Literature 1 can easily determine, at timings of arrival, shipping and inventory counting, stock statuses by a server gathering and processing information that has been read by a reader (also referred to as a scanner) from RFID tags attached to items, for example.

### CITATION LIST

### Patent Literature

PTL 1: Japanese Patent Laid-Open No. 2002-150241

When considering to make use of the RFID technology in situations such as inventory or distribution management where reliability is required in updating information, there is sometimes an issue of trade-off between simplicity of tag reading by a tag reader and the reliability in updating information based on reading results. For example, assume that a plurality of users are carrying tag readers and are working in a place where items to be shipped to a transaction partner or items having arrived from a partner are inspected. In a case where each tag reader is always operating, results of tag reading from RFID tags are accumulated over time without user's intentional operation on the tag readers. Such reading results include mixture of ones that should lead to information update and the others that should not, and it is not easy for the system to distinguish between them. Such an inconvenience will not occur if the tag readers are activated only when the information should be updated. However, in that case, there would be other problems that operations to repeatedly turn on and off a tag reader are cumbersome, and that a tag reader is erroneously kept in off-state at a timing when it should be active.

In light of the foregoing, the present invention aims at enhancing reliability of updating item management statuses based on results of tag reading.

### SUMMARY OF THE INVENTION

According to an aspect, there is provided an item management system including: a reading apparatus capable of reading, from a wireless device, identification information stored in the wireless device; a management unit configured to manage, in a database, a list of one or more items that are subject to a work by a user and a status of each item regarding the work; and a first wireless device attached to a first item included in the list and storing first identification information associated with the first item, wherein the management unit is configured to update the status of the first item when it is determined that the reading apparatus has read the first identification information from the first wireless device in a state where a first user has logged into the item management system and a first user operation representing a start of the work regarding the list has been detected. A corresponding method and an information processing apparatus are also provided.

Further features of the present invention will become apparent from the following description of exemplary embodiments with reference to the attached drawings.

### BRIEF DESCRIPTION OF THE DRAWINGS

FIG. 1 is a schematic view illustrating an example of a configuration of an item management system according to an embodiment.

FIG. 2 is a block diagram illustrating an example of a configuration of a tag reader according to an embodiment.

FIG. 3 is a block diagram illustrating an example of a configuration of a user terminal according to an embodiment.

FIG. 4 is a block diagram illustrating an example of a configuration of a management server according to an embodiment.

FIG. 5A is an explanatory diagram illustrating an example of a configuration of an item table according to an embodiment.

FIG. 5B is an explanatory diagram illustrating an example of a configuration of a place table according to an embodiment.

FIG. 6A is an explanatory diagram illustrating an example of a configuration of a reader table according to an embodiment.

FIG. 6B is an explanatory diagram illustrating an example of a configuration of a user table according to an embodiment.

FIG. 6C is an explanatory diagram illustrating an example of a configuration of a reading result table according to an embodiment.

FIG. 7 is an explanatory diagram illustrating an example of a configuration of a work table according to an embodiment.

FIG. 8 is an explanatory diagram illustrating an example of a configuration of a work detail table according to an embodiment.

FIG. 9 is an explanatory diagram for explaining an example of a menu screen of a graphic user interface (GUI) provided by a management server.

FIG. 10 is an explanatory diagram for explaining an example of a screen for registering a shipment list according to an embodiment.

FIG. 11A is a first explanatory diagram for explaining an example of transition between screens provided for pre-shipment confirmation.

FIG. 11B is a second explanatory diagram for explaining an example of transition between screens provided for pre-shipment confirmation.

FIG. 11C is a third explanatory diagram for explaining an example of transition between screens provided for pre-shipment confirmation.

FIG. 12 is an explanatory diagram for explaining a basic status update condition.

FIG. 13 is an explanatory diagram for explaining an example of an additional status update condition.

FIG. 14 is an explanatory diagram for explaining another example of an additional status update condition.

FIG. 15 is a flowchart illustrating an example of a flow of status update processing performed by a management server.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### 1. SYSTEM OVERVIEW

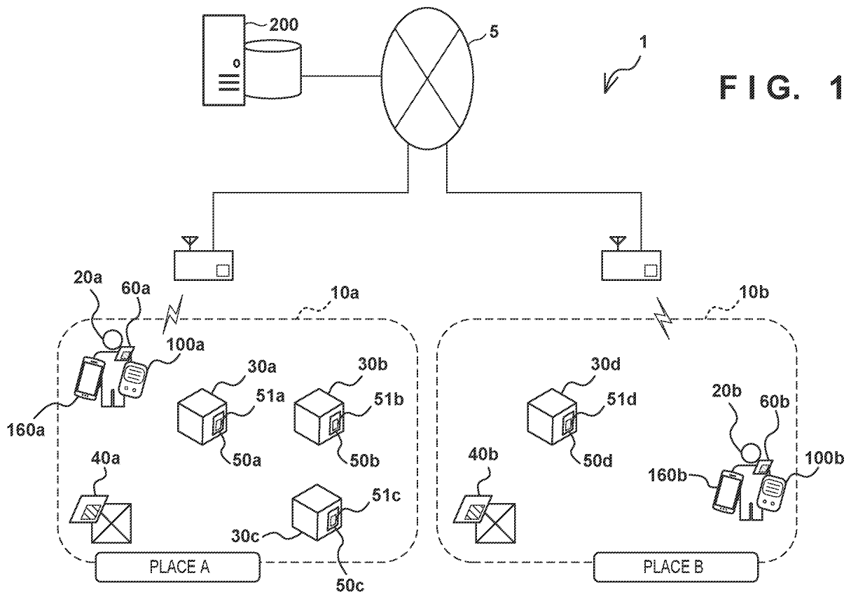

FIG. 1 is a schematic view illustrating an example of a configuration of an item management system 1 according to an embodiment. Herein, the item management system 1 is a system for managing statuses of works such as confirmation before shipment of items and inspection on items that have arrived. Note that the technology according to the present disclosure is not limited to the above examples, and may be applied to various applications that involve updates of statuses regarding item management. An item may be a non-living object (for example, a machine, equipment, a tool, material, a consumable good, a component, a vehicle, or a robot) or a living object (for example, an animal or a plant).

FIG. 1 illustrates two places 10a and 10b under management of the item management system 1. There are a user 20a, and items 30a, 30b and 30c in the place 10a. There are a user 20b, and an item 30d in the place 10b. The users 20a and 20b can freely move across the places 10a and 10b (and other places).

The item management system 1 makes use of wireless devices, which are also referred to as tags, for the purpose of item management. In the present embodiment, the item management system 1 includes three types of tags. A first type of tags (first wireless devices) are item tags which are attached to respective items managed in the item management system 1. A second type of tags (second wireless devices) are user tags carried by users. A third type of tags (third wireless devices) are position tags which are installed in respective places in which a work is conducted by the users in the item management system 1.

In the example of FIG. 1, position tags 40a and 40b are installed in the places 10a and 10b, respectively. The installation position of each of the position tags 40a and 40b may be fixed or can be changed. When a place itself moves (for example, a work-site may move), the corresponding position tag may be relocated in conjunction with the movement of the place. Item tags 50a, 50b, 50c and 50d are attached to the items 30a, 30b, 30c and 30d, respectively. Each item tag moves as a corresponding item moves. The user 20a carries a user tag 60a, and the user 20b carries a user tag 60b. The user tags 60a and 60b may be IC card-type devices such as employee ID cards or admission cards, for example. Note that, in this specification, the expression that a user carries a certain target should broadly comprehend various modes in which the user moves together with the target (for example, moves in a state where he or she holds or wears the target, etc.).

In the following descriptions, the places 10a and 10b are collectively referred to as places 10 by omitting the trailing characters from the reference signs when they do not need to be distinguished from each other. The same applies to the items 30 (items 30a, 30b, . . . ), the position tags 40 (40a, 40b, . . . ), the item tags 50 (item tags 50a, 50b, . . . ), and the user tags 60 (user tags 60a, 60b, . . . ), as well as any other elements. The number of places 10 and the number of items 30 managed in the item management system 1 are not limited to the example illustrated in FIG. 1 but may be any numbers. Likewise, the number of users 20 utilizing the item management system 1 is also not limited to the example illustrated in FIG. 1 but may be any number.

In the present embodiment, each of the tags such as the position tags 40, the item tags 50 and the user tags 60 is assumed to be a passive-type RFID tag (a passive tag). A passive tag is composed of: a small integrated circuit (IC) chip with an embedded memory; and an antenna, and has identification information for identifying the tag and some other information stored in the memory. In this specification, identification information is simply referred to as an ID, and identification information for identifying a tag is referred to as a tag ID. It should be noted that the tag ID may be considered as information for identifying an object to which the tag is attached. The IC chip of a passive tag operates by utilizing energy of an electromagnetic wave emitted from a tag reader, and modulates the information such as the tag ID and some other information stored in the memory into an information signal to transmit (send back) the information signal from the antenna.

In the example of FIG. 1, the item tags 50a, 50b, 50c and 50d have specific tag IDs 51a, 51b, 51c and 51d embedded in the tags, respectively. The tag ID 51 (first identification information) of each item tag 50 is associated with the item 30 to which the item tag 50 is attached in a database described below. The user tags 60a and 60b also have respective specific tag IDs embedded in the tags. The tag ID (second identification information) of each user tag 60 is associated with the user 20 who carries the user tag 60. The position tags 40a and 40b also have respective specific tag IDs embedded in the tags. The tag ID (third identification information) of each position tag 40 is associated with the place in which the position tag 40 is installed.

It should be noted that, in another embodiment, each tag may be an active-type RFID tag. If each tag actively (for example, periodically) transmits information to its vicinity by utilizing power from a built-in battery, such a tag may be called a beacon tag. In a further embodiment, each tag may be a wireless device which sends back information in response to a signal from a reader in accordance with Near Field Communication (NFC) protocol or Bluetooth (registered trademark) protocol, for example. Each tag may have any name such as an IC tag, an IC card, or a responder.

The user 20a carries a tag reader 100a and a user terminal 160a in addition to the user tag 60a. The user 20b carries a tag reader 100b and a user terminal 160b in addition to the user tag 60b. The tag reader 100 and the user terminal 160 may be considered to constitute a portable system that is carried by the user 20. The item management system 1 includes such a portable system, and a management server 200. One or both of the tag readers 100 and the user terminals 160, and the management server 200 are connected to a network 5. The network 5 may be a wired network, a wireless network, or any combination thereof. Examples of the network 5 may include the Internet, an intranet, and a cloud network.

The tag reader 100 is a reading apparatus that is capable of reading, from wireless devices such as RFID tags, information stored in the wireless devices. The tag reader 100 can detect an item 30 to which an item tag 50 is attached by reading a tag ID 51 from the item tag 50, for example. The tag reader 100 performs reading periodically or in response to a certain trigger such as a user operation, and transmits a tag reading result to the management server 200. The tag reader 100 may be capable of communicating with the management server 200 directly or indirectly via a certain relay apparatus (for example, the user terminal 160). An example of a particular configuration of the tag reader 100 will be further described below.

The user terminal 160 may be any type of terminal apparatus such as a notebook personal computer (PC), a tablet PC, a smartphone, or a smart watch, for example. The user terminal 160 may be utilized for the item management system 1 to interact with a user 20. An example of a particular configuration of the user terminal 160 will be further described below.

The management server 200 is an information processing apparatus that manages work-related statuses, position information and other information of a plurality of items 30 in a database. The management server 200 may be implemented as an application server, a database server, or a cloud server by using a high-end general-purpose computer, for example. The management server 200 receives tag reading results from tag readers 100, and updates the database based on the received tag reading results. An example of a particular configuration of the management server 200 will be further described below.

Though a single management server 200 is illustrated in FIG. 1, the functions of the management server 200, which will be described in detail below, may be provided by a single apparatus or by physically-separate multiple apparatuses which operate in conjunction with each other. In addition, though an example where the management server 200 maintains a database will be described in the present embodiment, an apparatus other than the management server 200 may maintain a part or all of the database. For example, a part of data may be maintained by a wireless device, a tag reader 100 or a user terminal 160.

Note that FIG. 1 shows an example where the tag reader 100 and the user terminal 160 are physically-separate apparatuses. However, the tag reader 100 may have a part or all of the functions of the user terminal 160 described below, or the user terminal 160 may have a part or all of the functions of the tag reader 100 described below, for example. Moreover, the functions of the management server 200 described in the present embodiment may be realized within the user terminal 160.

### 2. CONFIGURATION EXAMPLE OF TAG READER

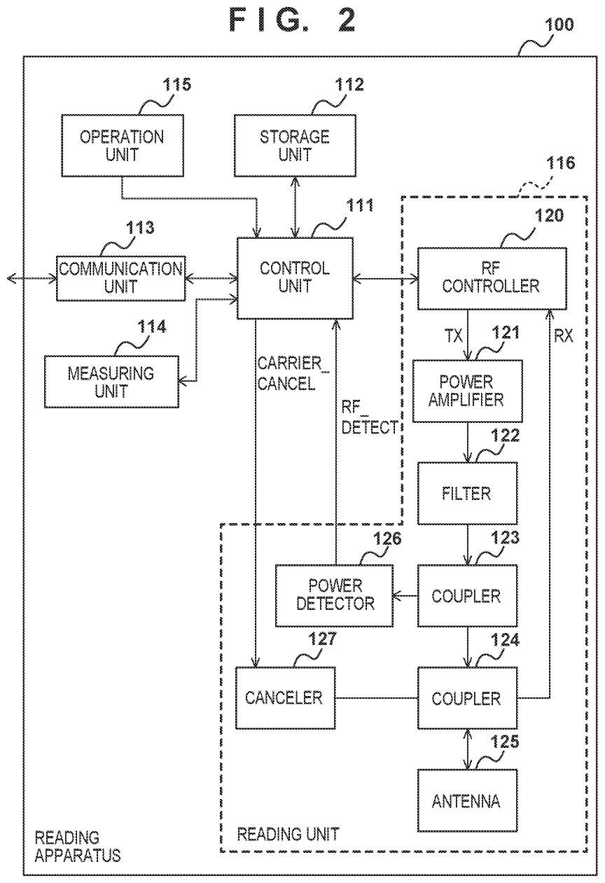

FIG. 2 is a block diagram illustrating an example of a configuration of the tag reader 100 according to an embodiment. With reference to FIG. 2, the tag reader 100 comprises a control unit 111, a storage unit 112, a communication unit 113, a measuring unit 114, an operation unit 115, and a reading unit 116.

The control unit 111 consists of a memory to store computer programs, and one or more processors (for example, central processing units (CPUs)) to execute the computer programs. The control unit 111 controls overall functionality of the tag reader 100 described in this specification. For example, the control unit 111 causes the reading unit 116 to perform reading from an RFID tag within a tag reading range, and causes the storage unit 112 to temporarily store the read information, the time of the reading and the received signal level as reading result data. In parallel to the reading from RFID tags, the control unit 111 also causes the measuring unit 114 to measure the position of the tag reader 100, and the storage unit 112 to store a measurement result Then, the control unit 111 transmits, to the management server 200 via the communication unit 113, the reading result data and the measurement result data stored in the storage unit 112 together with reader identification information (also referred to as a reader ID) that identifies the apparatus itself.

The storage unit 112 may include any kind of storage medium such as a semiconductor memory (a read only memory (ROM), a random access memory (RAM), or the like), an optical disk, or a magnetic disk, for example. In the present embodiment, the storage unit 112 stores the above-described reading result data, measurement result data, and the reader ID of the tag reader 100.

The communication unit 113 is a communication interface for the tag reader 100 to communicate with the management server 200. For example, the communication unit 113 may be a wireless local area network (WLAN) interface that communicates with a WLAN access point, or a cellular communication interface that communicates with a cellular base station. Alternatively, the communication unit 113 may be a connection interface (e.g. a Bluetooth (registered trademark) interface or a universal serial bus (USB) interface) for connection with a relay apparatus.

The measuring unit 114 is a unit that is capable of measuring a position of the tag reader 100. In the present embodiment, the measuring unit 114 uses the self-localization technique, also referred to as pedestrian dead reckoning (PDR) to measure an amount of relative movement of the tag reader 100 from a certain reference position, and outputs the measured amount of movement to the control unit 111. The reference position of measurement of the amount of relative movement may be, for example, the position of the tag reader 100 at the time when the tag reader 100 is activated. The measuring unit 114 may have sensors including a three-axis acceleration sensor, a gyro sensor, and a geomagnetic sensor to perform PDR, for example. As described below, in the present embodiment, the positional coordinates of the installation position of each position tag 40 is known and registered in a database. Therefore, the control unit 111 can estimate the current (positional coordinates of) absolute position of the tag reader 100 based on the amount of relative movement from the point in time when it detected a position tag 40 to the current point in time, and the known positional coordinates of that position tag 40.

In another embodiment, the measuring unit 114 may measure the current geographical position of the tag reader 100 by utilizing the global positioning system (GPS). In yet another embodiment, the measuring unit 114 may perform base station positioning or wireless LAN positioning in which the current position is estimated by utilizing known positional coordinates of a base station or a wireless LAN access point to which the apparatus is connected.

The operation unit 115 detects a user operation. The operation unit 115 includes physical input devices such as a button, a switch, or a lever disposed on a housing of the tag reader 100, for example. The operation unit 115 detects an operation by the user 20 through an input device, and outputs an operation signal to the control unit 111. In addition, the operation unit 115 may include an audio input interface such as a microphone.

The reading unit 116 is a unit that is capable of reading, from each of the tags such as the position tags 40, the item tags 50, and the user tags 60 described above, information stored in the tag. With reference to FIG. 2, the reading unit 116 includes an RF controller 120, a power amplifier 121, a filter 122, a first coupler 123, a second coupler 124, an antenna 125, a power detector 126, and a canceler 127. The RF controller 120 outputs a transmission signal (for example, a signal modulated in the UHF band) from a TX terminal to the power amplifier 121 in accordance with control by the control unit 111. The power amplifier 121 amplifies the transmission signal input from the RF controller 120 to output it to the filter 122. The amplification rate of the transmission signal here may be controllable in variable manner, and a higher amplification rate will enhance an output strength of an electromagnetic wave emitted from the tag reader 100. The filter 122 may be a low-pass filter, for example, and filters out unnecessary frequency components from the transmission signal amplified by the power amplifier 121. The first coupler 123 distributes the transmission signal that has passed the filter 122 to the coupler 124 and the power detector 126. The second coupler 124 outputs the transmission signal input from the first coupler 123 to the antenna 125, and outputs a received signal input from the antenna 125 to the RF controller 120. The antenna 125 transmits the transmission signal input from the coupler 124 to the air as an electromagnetic wave. Further, the antenna 125 receives a signal that has been sent back from an RFID tag that exists within the reading range of the tag reader 100 in response to the transmission signal, and outputs the received signal to the coupler 124. As an example, the antenna 125 may be an omnidirectional antenna. As another example, the antenna 125 may be a directional antenna of which beam direction can be variably controlled. The power detector 126 detects a power level of the signal input from the first coupler 123, and outputs a signal ‘RF_DETECT’ indicative of the detected power level to the control unit 111. The canceler 127 receives a signal ‘CARRIER_CANCEL’ indicative of a power level of a carrier from the control unit 111. Then, the canceler 127 cancels the carrier component of the received signal at the second coupler 124 from the antenna 125 based on the CARRIER_CANCEL, and thereby extracts an intended signal component of the received signal to be output to the RX terminal of the RF controller 120. The RF controller 120 demodulates the signal input from the RX terminal to obtain a tag ID and other information sent back from the RFID tag, and outputs the obtained information to the control unit 111. The RF controller 120 also measures a reception level (also referred to as received strength) of the signal input from the RX terminal, and outputs the measurement result to the control unit 111.

In the present embodiment, the reading unit 116 can attempt tag reading periodically (for example, once per second) without requiring any explicit command from a user. Data transmission from the communication unit 113 to the management server 200 can also be performed periodically (for example, every few seconds) or whenever the tag reading is done without requiring any explicit command from a user. The control unit 111 may exclude, from the data to be transmitted, the same record as the most recent record that has already been transmitted in a predetermined time period to omit redundant data transmission and reduce a communication load. When a reception level of a received signal from an RFID tag exceeds a preset minimum detection level, the control unit 111 may determine to have detected the RFID tag, and transmit a reading result data about the detected RFID tag to the management server 200. Noted that, in another embodiment, one or both of an attempt of tag reading by the reading unit 116 and data transmission to the management server 200 may be performed in response to detecting a user input via the operation unit 115. In a case where the communication unit 113 performs communication with the management server 200 indirectly via a relay apparatus, the data transmission to the management server 200 may be performed only while there is an effective connection between the communication unit 113 and the relay apparatus.

### 3. CONFIGURATION EXAMPLE OF USER TERMINAL

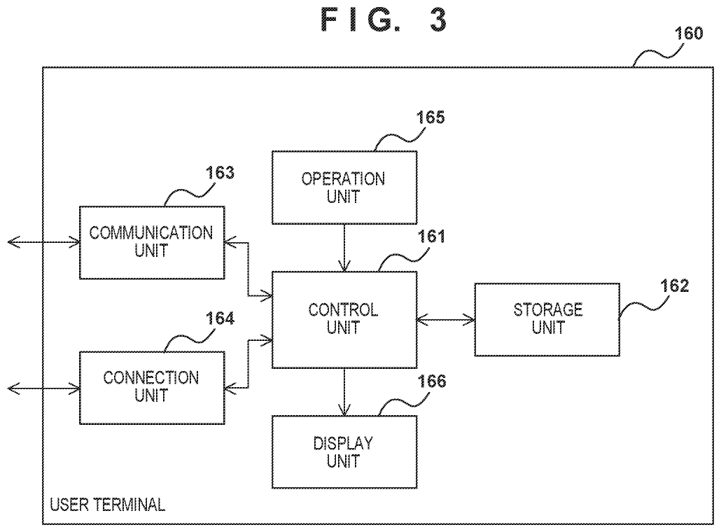

FIG. 3 is a block diagram illustrating an example of a configuration of the user terminal 160 according to an embodiment. With reference to FIG. 3, the user terminal 160 comprises a control unit 161, a storage unit 162, a communication unit 163, a connection unit 164, an operation unit 165, and a display unit 166.

The control unit 161 consists of a memory to store computer programs, and one or more processors (for example, CPUs) to execute the computer programs. The control unit 161 controls overall functionality of the user terminal 160 described in this specification. For example, when a work by a user such as pre-shipment confirmation or acceptance inspection is carried out in the item management system 1, the control unit 161 accesses the management server 200 via the communication unit 163, and causes the display unit 166 to display an application screen provided by the management server 200. On this screen, the user 20 can give an instruction to start or stop updating a work status, or can check its progress. Some examples of application screens provided by the management server 200 will further be described below.

The storage unit 162 may include any kind of storage medium such as a semiconductor memory (ROM, RAM, or the like), an optical disk, or a magnetic disk, for example. In the present embodiment, the storage unit 162 temporarily store work-related information received from the management server 200 described below for the purpose of screen display, for example.

The communication unit 163 is a communication interface for the user terminal 160 to communicate with the management server 200. For example, the communication unit 163 may be a WLAN interface or a cellular communication interface.

The connection unit 164 is a connection interface for connecting the user terminal 160 to peripheral equipment. For example, the connection unit 164 may be a Bluetooth (registered trademark) interface or a USB interface. In a case where the user terminal 160 relays communications between the tag reader 100 and the management server 200, the connection unit 164 establishes a communication connection with the tag reader 100.

The operation unit 165 receives operations or information inputs from the user 20. The operation unit 165 includes input devices such as a touch sensor, a key pad, a keyboard, a button, or a pointing device, for example. The operation unit 165 detects an operation by the user 20 through an input device, and outputs an operation signal to the control unit 161. In addition, the operation unit 165 may further include some other types of input devices including an audio input interface such as a microphone, a sensor to detect a vibration, or the like.

The display unit 166 displays an image and information. The display unit 166 may be a liquid crystal display (LCD) or an organic light emitting diode (OLED), for example. Though not illustrated in FIG. 3, the user terminal 160 may include a further device for performing a notification to the user 20 such as a speaker and a vibrator.

### 4. CONFIGURATION EXAMPLE OF MANAGEMENT SERVER

### 4-1. Basic Configuration

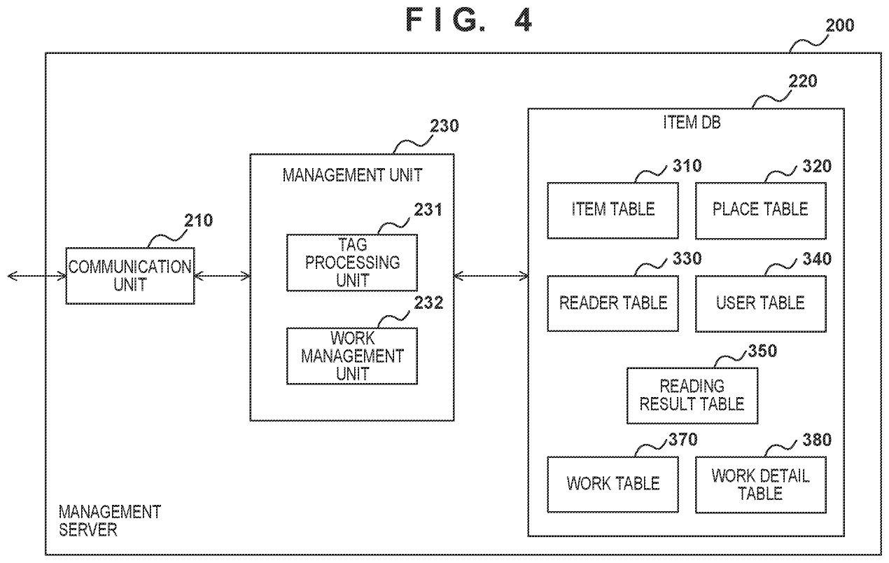

FIG. 4 is a block diagram illustrating an example of a configuration of the management server 200 according to an embodiment. With reference to FIG. 4, the management server 200 comprises a communication unit 210, an item database (DB) 220, and a management unit 230.

The communication unit 210 is a communication interface for the management server 200 to communicate with other apparatuses. The communication unit 210 may be a wired communication interface or a wireless communication interface. In the present embodiment, the communication unit 210 communicates with the tag readers 100 and the user terminals 160. The item DB 220 is a database that stores work-related statuses, position information and other information of each of a plurality of items under management of the system. In the present embodiment, the item DB 220 includes an item table 310, a place table 320, a reader table 330, a user table 340, a reading result table 350, a work table 370, and a work detail table 380. The management unit 230 is a set of software modules that provide management functions for managing data within the item DB 220. The individual software modules can run by one or more processors (not shown) of the management server 200 executing computer programs stored in a memory (not shown). In the present embodiment, the management unit 230 includes a tag processing unit 231 and a work management unit 232.

### 4-2. Data Configuration Examples

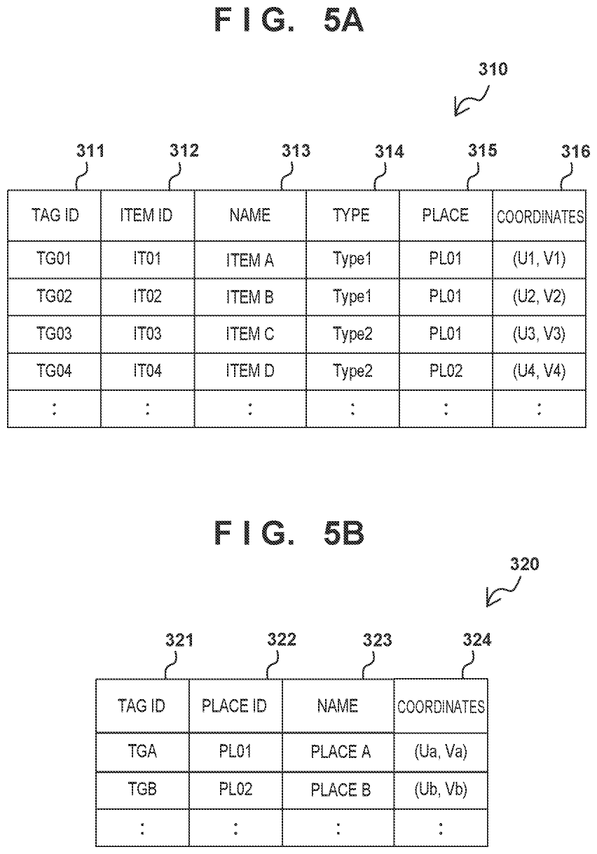

FIGS. 5A and 5B illustrate respective configuration examples of the item table 310 and the place table 320 of the item DB 220.

The item table 310 has six data elements, namely Tag ID 311, Item ID 312, Name 313, Type 314, Place 315, and Coordinates 316. Tag ID 311 is identification information that uniquely identifies an item tag 50 attached to each of the items 30 under management of the system. The value of Tag ID 311 is the same as the value of the tag ID stored within the corresponding item tag 50. Item ID 312 is identification information that uniquely identifies each item 30. Name 313 represents a name of each item 30. In the example of FIG. 5A, the items identified by item IDs “IT01”, “IT02”, “IT03” and “IT04” are given the names of “Item A”, “Item B”, “Item C” and “Item D”, respectively. “Item A”, “Item B”, “Item C” and “Item D” here may correspond respectively to the items 30a, 30b, 30c and 30d illustrated in FIG. 1. Type 314 represents a type into which each item 30 is classified. In the example of FIG. 5A, the type of “Item A” and “Item B” is “Type 1”, and the type of “Item C” and “Item D” is “Type 2”. The values of Name 313 and Type 314 of each item 30 are determined by a user, and may be registered in advance via a user interface provided by the management unit 230. Alternatively, the values of Name 313 and Type 314 may be stored in item tags 50 as item-related information and read by a tag reader 100. In the latter case, upon initial tag reading from the item tag 50 of each item 30, the management server 200 may receive the values of Name 313 and Type 314 of that item 30 from the tag reader 100, and register them in the item table 310. Place 315 represents a place where each item 30 has been last detected by a tag reader 100 with a place ID which identifies that place. In the example of FIG. 5A, “Item A”, “Item B” and “Item C” exist in the place identified by the place ID “PL01”. “Item D” exists in the place identified by the place ID “PL02”. Coordinates 316 represents positional coordinates of a point at which each item is estimated to be positioned. The values of Place 315 and Coordinates 316 may be updated by the tag processing unit 231 when the tag reader 100 has detected a movement of an item as will be described below.

The place table 320 has four data elements, namely Tag ID 321, Place ID 322, Name 323, and Coordinates 324. Tag ID 321 is identification information that uniquely identifies a position tag 40 installed in each of the places 10 under management of the system. The value of Tag ID 321 is the same as the value of the tag ID stored within the corresponding position tag 40. Place ID 322 is identification information that uniquely identifies each place 10. Name 323 represents a name of each place 10. In the example of FIG. 5B, the name of the place 10 identified by the place ID “PL01” is “Place A”, and the name of the place 10 identified by the place ID “PL02” is “Place B”. Noted that these names may be, in practice, such as “Factory”, “Warehouse” and “Work Site”, for example. Coordinates 324 represents positional coordinates of an installation position of a position tag 40 installed in each place 10.

In the present specification, the position information may be, for example, information indicating a certain position with positional coordinates or an identifier that identifies one of a plurality of predefined places. That is, each of Place 315 and Coordinates 316 of the item table 310 and Coordinates 324 of the place table 320 may serve as a kind of position information. The positional coordinates may be two-dimensional coordinates indicating a position in a horizontal plane, or may be three-dimensional coordinates that includes a component of height direction as well.

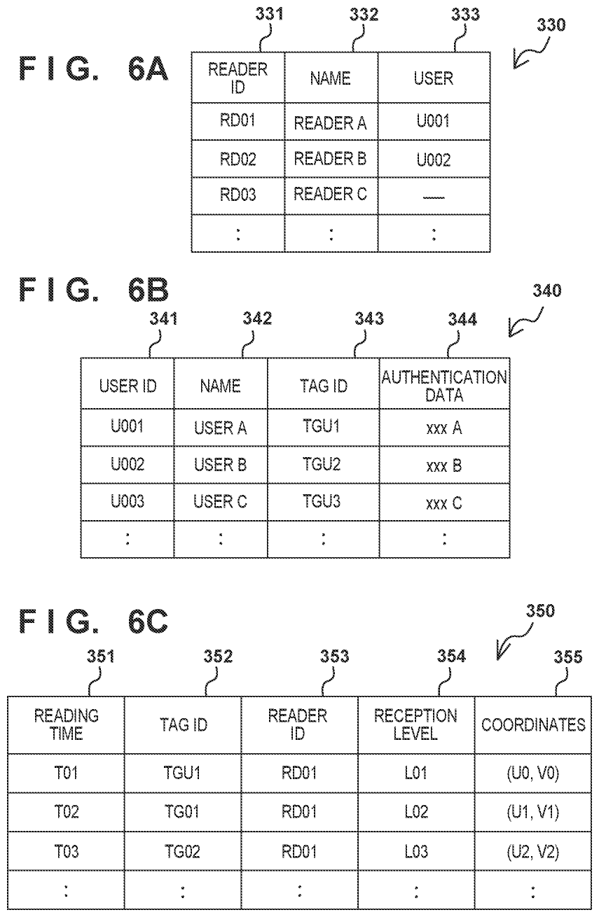

FIGS. 6A to 6C illustrate respective configuration examples of the reader table 330, the user table 340, and the reading result table 350.

The reader table 330 has three data elements, namely Reader ID 331, Name 332, and User 333. Reader ID 331 is identification information that uniquely identifies each of the tag readers 100 utilized in the system. Name 332 represents a name of each tag reader. In the example of FIG. 6A, the tag readers 100 identified by reader IDs “RD01”, “RD02”, and “RD03” are given the names of “Reader A”, “Reader B”, and “Reader C”, respectively. User 333 identifies a user 20 who is using each tag reader with a user ID that identifies the user 20. Some examples of techniques to determine which user 20 is using a certain tag reader 100 will be described below. Note that there may be a tag reader 100 of which associated user is unknown among the users 20 and the field of User 333 for such a tag reader 100 may be blank.

The user table 340 has four data elements, namely User ID 341, Name 342, Tag ID 343, and Authentication Data 344. User ID 341 is identification information that uniquely identifies each of the users 20 who utilize the item management system 1. Name 342 represents a name of each user. In the example of FIG. 6B, the name of the user 20 identified by the user ID “U001” is “User A”, the name of the user 20 identified by the user ID “U002” is “User B”, and the name of the user 20 identified by the user ID “U003” is “User C”. Tag ID 343 is identification information that uniquely identifies a user tag 60 carried by each user 20. The value of Tag ID 343 is the same as the value of the tag ID stored within the corresponding user tag 60. Authentication Data 344 is an element in which data utilized for user authentication by each user 20 at the time of logging in the item management system 1 is stored. The user authentication may be performed with any authentication scheme such as password authentication or biometric authentication, for example.

The reading result table 350 is a table for accumulating records of reading result data received from the tag readers 100 (hereinafter referred to as reading result records). The reading result table 350 has five data elements, namely Reading Time 351, Tag ID 352, Reader ID 353, Reception Level 354, and Coordinates 355. Reading Time 351 represents a time at which a tag ID was read for each reading result record. Tag ID 352 represents the tag ID that has been read for each reading result record. Reader ID 353 is identification information that identifies the tag reader 100 that has performed tag reading for each reading result record. In the example of FIG. 6C, the first record in the reading result table 350 indicates that the tag reader 100 identified by the reader ID “RD01” has read the tag ID “TGU1” (for example, the tag ID 41a of the user tag 60a of the user 20a) at time “T01”. The second record indicates that the tag reader 100 has read the tag ID “TG01” (for example, the tag ID of the item tag 50a of the item 30a) at time “T02”. The third record indicates that the tag reader 100 has read the tag ID “TG02” (for example, the tag ID of the item tag 50b of the item 30b) at time “T03”. Reception Level 354 represents a reception level of a signal received by the tag reader 100 at the time of tag reading for each reading result record. Coordinates 355 represents positional coordinates of a point at which the tag reader 100 existed at the time of tag reading (that is, coordinates based on measurement result data received from the tag reader 100).

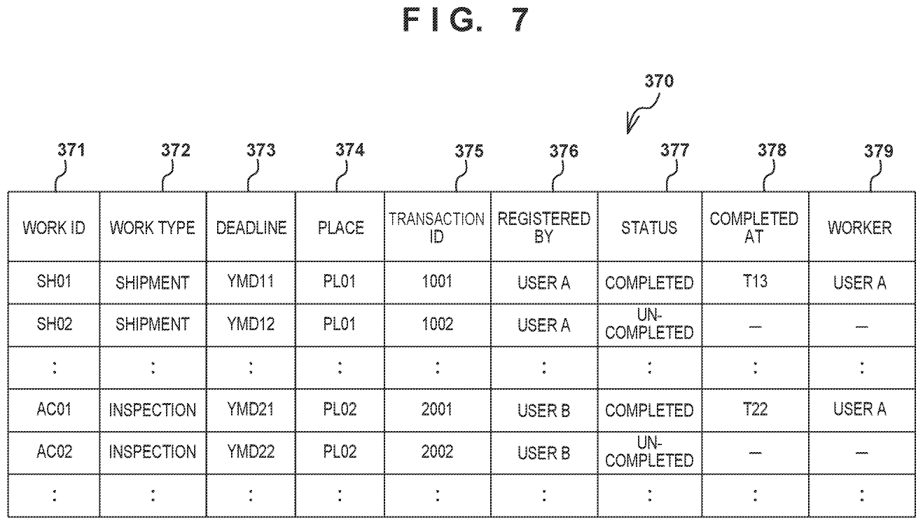

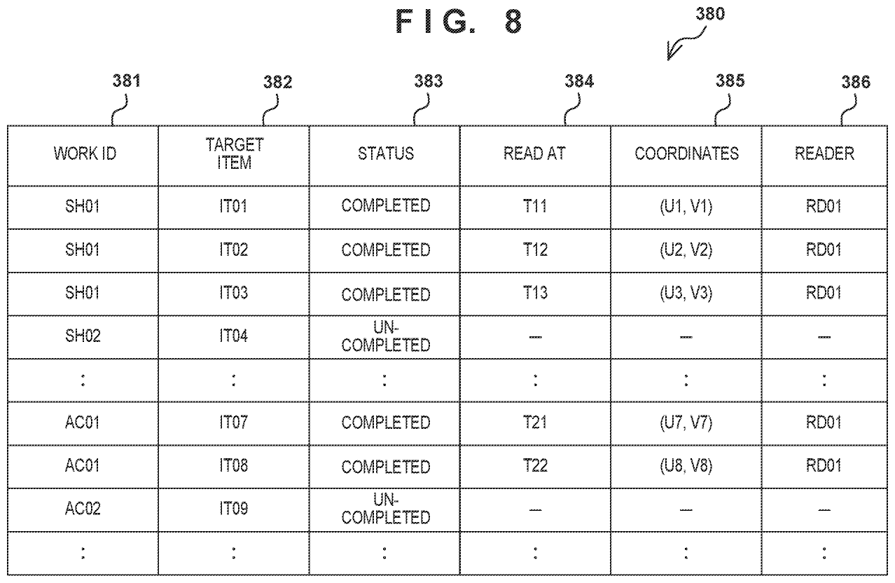

FIG. 7 illustrates an example of a configuration of the work table 370. The work table 370 is a table for storing information related to works to be carried out by the users 20 in the item management system 1. The work table 370 has nine data elements, namely Work ID 371, Work Type 372, Deadline 373, Place 374, Transaction ID 375, Registered-By 376, Status 377, Completed-At 378, and Worker 379. Work ID 371 is identification information that uniquely identifies each work. Work Type 372 represents a type of each work. In the present embodiment, the value of Work Type 372 may indicate “Shipment” or “Inspection”. In the example of FIG. 7, the types of works identified by work IDs “SH01” and “SH02” are set to “Shipment” representing pre-shipment confirmation, and the types of works identified by work IDs “AC01” and “AC02” are set to “Inspection” representing acceptance inspection. Deadline 373 represents a deadline by which each work should be completed. Place 374 represents a place in which each work is scheduled to be carried out with a place ID that identifies the place. Transaction ID 375 is identification information for associating each work with transaction information. Though it is not illustrated, the item DB 220 may further include a table that maintains transaction information such as a name of a transaction, a name of a transaction partner, an address, a name of person-in-charge, and a date of contract, for example, and Transaction ID 375 identifies a record of such transaction information. Registered-By 376 represents a name of a user 20 who registered each record of the work table 370 (hereinafter, referred to as a work record) in the work table 370. Status 377 represents a status of work progression for each work record. The value of Status 377 may be “Uncompleted”, “In Progress”, “Completed” or “Deregistered”, for example. Completed-At 378 represents, for a work record of which work has already been completed, the time (date and time) at which the work was completed. Worker 379 represents a name of a user 20 who has completed each work. For work records for which Status 377 indicates “Uncompleted”, the fields of Completed-At 378 and Worker 379 may be blank.

FIG. 8 illustrates an example of a configuration of the work detail table 380. The work detail table 380 is a table for maintaining a list of one or more target items of each work registered in the work table 370 and statuses regarding the work for respective items. The work detail table 380 has six data elements, namely Work ID 381, Target Item 382, Status 383, Read-At 384, Coordinates 385, and Reader 386. Work ID 381 is identification information that identifies one of work records registered in the work table 370. Target Item 382 represents one of target items of the work identified by the value of Work ID 381 with an item ID that identifies the item. As seen in FIG. 8, it is possible to register one or more target items for one work in the work detail table 380. Status 383 represents whether tag reading for each target item has been completed or not. The value of Status 383 may be “Uncompleted”, “Completed” or “Deleted”, for example. In a case where the value of Status 383 indicates “Completed” for a certain target item, it means that confirmation on existence of the target item has been done in the corresponding work. Read-At 384 represents, for a target item of which tag has already been read, the time (date and time) at which the tag was read. Coordinates 385 represents, for a target item of which tag has already been read, positional coordinates of a point at which the tag was read. Reader 386 represents, for a target item of which tag has already been read, a tag reader 100 that has read the tag with a reader ID that identifies the tag reader 100. For work records for which Status 383 indicates “Uncompleted”, the fields of Read-At 384, Coordinates 385 and Reader 386 may be blank.

### 4-3. Position Tracking

The tag processing unit 231 processes the reading result data and the measurement result data received from the tag readers 100. For example, the tag processing unit 231 adds, to the reading result table 350, each record of reading result data received from the tag readers 100 via the communication unit 210 as a reading result record. When adding a reading result record to the reading result table 350, the tag processing unit 231 determines values of positional coordinates to be set to Coordinates 355 based on measurement data received from the tag readers 100. The values set to Coordinates 355 represent positional coordinates of a tag reader 100 at the time of reading the tag. The values may be sum of the positional coordinates of detection position of a position tag 40 and the amount of relative movement of the tag reader 100 from that detection position, for example.

Upon receiving reading result data for an item tag 50, the tag processing unit 231 also updates the values of Coordinates 316 of the item table 310. The values of Coordinates 316 of each item 30 in the item table 310 may be the same as the values of Coordinates 355 of the reading result record most-recently added to the reading result table 350 for that item 30. Furthermore, the tag processing unit 231 also updates the field of Place 315 of the corresponding item 30 in the item table 310 in a case where the place 10 in which the item 30 exists has changed.

### 4-4. Work Status Management

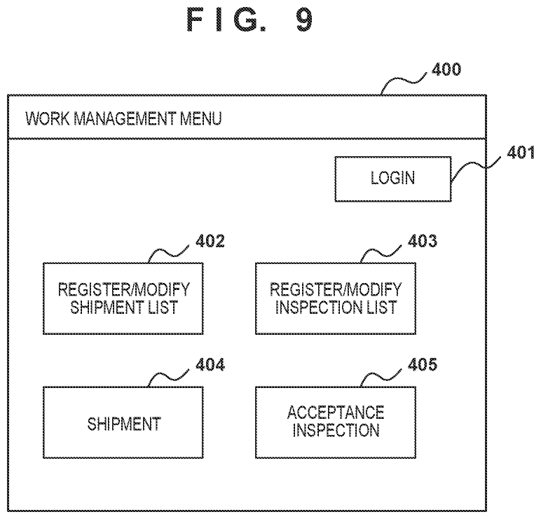

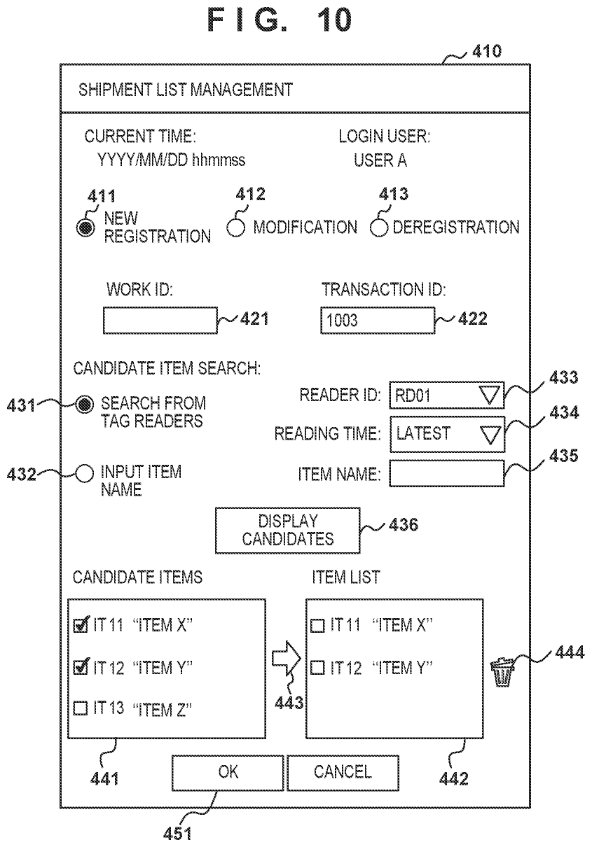

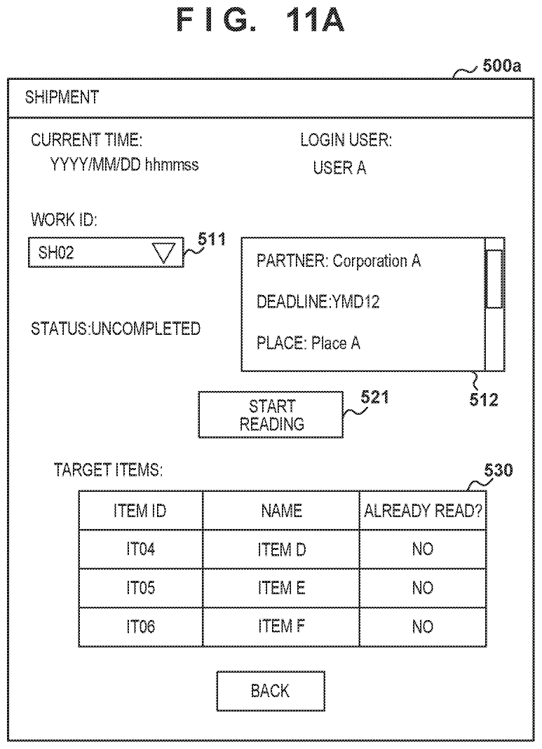

The work management unit 232 accepts login by a user 20 to the item management system 1, and provides a user terminal 160 of the user 20 who has logged in with an application screen related to a work to be carried out by the user 20. The application herein may be a web browser or a dedicated application for item management that runs in the user terminal 160, for example. The application screen may be displayed by the display unit 166 of the user terminal 160. Prior to the login, the work management unit 232 causes the display unit 166 of the user terminal 160 to display a menu screen 400 as illustrated in FIG. 9 in response to an access from the user terminal 160, for example.

With reference to FIG. 9, the menu screen 400 includes five buttons 401, 402, 403, 404 and 405. When the user 20 operates the button 401 in the menu screen 400, the work management unit 232 prompts the user 20 to input authentication information such as an ID and a password, for example, and perform user authentication based on the input authentication information. When the user authentication is successful, the user 20 enters a login state in the item management system 1. The login state continues until the user 20 selects logout (or until a predetermined time length elapses without any operation being performed).

### (1) Work Registration

The button 402 is a button for calling a management screen utilized when a shipment list is registered or modified. The button 403 is a button for calling a management screen utilized when an inspection list is registered or modified. Also when the user 20 operates the button 402 or 403, the work management unit 232 may prompt the user 20 to input authentication information if he or she has not yet logged in, and perform user authentication. As a shipment list management screen and an inspection list management screen may have similar configurations, only the shipment list management screen will be described herein.

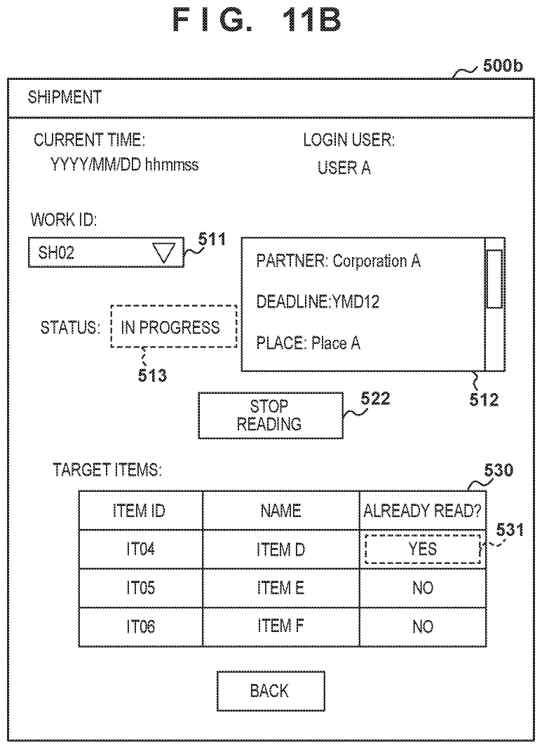

FIG. 10 illustrates the shipment list management screen 410 as an example. The shipment list management screen 410 includes radio buttons 414, 412, and 413 for the user to select a management option, for example. The radio button 411 may be selected when newly registering a shipment list. The radio button 412 may be selected when modifying a registered shipment list. The radio button 413 may be selected when deregistering a registered shipment list. Note that the shipment list herein means a list of one or more items that are subject to a pre-shipment confirmation.

The shipment list management screen 410 further includes a work ID field 421 and a transaction ID field 422. The work ID field 421 displays a work ID corresponding to a shipment list to be newly registered or an existing shipment list to be modified. In the case of newly-registering a shipment list, the work management unit 232 may automatically assign a work ID corresponding to the shipment list to be newly registered such that it does not conflict with an existing work ID. The transaction ID field 422 accepts an input of a transaction ID corresponding to a shipment list to be newly registered or an existing shipment list to be modified, or displays a transaction ID that has already been input. In the case of modifying or deregistering a shipment list, the work management unit 232 searches the work table 370 for a corresponding work when the user 20 enters a work ID or a transaction ID in the corresponding field 421 or 422. Then, the work management unit 232 obtains information related to a work specified as a result of the search from the work table 370 and the work detail table 380, and reflect it in the shipment list management screen 410. Note that the search key to search for an intended work is not limited to a work ID or a transaction ID, but may be any one or combination of information elements maintained in the item DB 220.

The shipment list management screen 410 further includes radio buttons 431 and 432 for the user to select a search mode to search for a candidate item to be included in the shipment list, a reader ID field 433, a reading time field 434, and an item name field 435. In addition, the shipment list management screen 410 includes a candidate display button 436, a candidate item area 441, an item list area 442, an add icon 443, a delete icon 44, and an OK button 451.

The radio button 431 may be selected when searching for a candidate item from results of tag reading by a tag reader 100. When the user selects the radio button 431, the user designates a reader ID and a reading time as search conditions in the reader ID field 433 and the reading time field 434, and operates the candidate display button 436. Then, the work management unit 232 extracts, from the reading result table 350, a list of item tags 50 that were detected by the designated tag reader 100 at a time close to the designated time. Then, the work management unit 232 causes the list of items 30 corresponding to the extracted item tags 50 to be displayed in the candidate item area 441.

The radio button 432 may be selected when searching for a candidate item by designating an item name of a specific item 30. When the user selects the radio button 432, the user designates a name of an intended item in the item name field 435, and operates the candidate display button 436. Then, the work management unit 232 specifies an item having the designated name in the item table 310, and causes the specified item 30 to be displayed in the candidate item area 441. The work management unit 232 may specify one or more items 30 by fuzzy search on item names based on a string designated in the item name field 435, and cause the list of specified items 30 to be displayed in the candidate item area 441.

In the example of FIG. 7, three pairs of item IDs and names of items 30 are displayed in the candidate item area 441 together with checkboxes. The user can add one or more candidate items to the shipment list by toggling the checkboxes of the candidate items displayed in the candidate item area 441 and operating the add icon 443.

The item list area 442 is an area in which a list of target items included in the shipment list to be newly registered or being modified is displayed. In the example of FIG. 7, two pairs of item IDs and names of items 30 are displayed in the item list area 442 together with checkboxes. The user can delete one or more target items from the list by toggling the checkboxes of the target items displayed in the item list area 442 and operating the delete icon 444.

Once the list of target items displayed in the item list area 442 is set as intended, the user operates the OK button 451. Then, the work management unit 232 reflects the shipment list modified by the user and related information in the work table 370 and the work detail table 380. For example, in the case of newly-registering a shipment list, the work management unit 232 adds a record of a newly-assigned work ID to the work table 370. The information such as Deadline 373 and Place 374 of the work table 370 may be input through further input fields that are not illustrated in the figure, or may be obtained from another table based on the transaction ID. The work management unit 232 also adds one or more records, each identified by a pair of the work ID of the new shipment list and an item ID of a target item, to the work detail table 380. The values of Status 377 of the newly-added record of the work table 370 and Status 383 of the newly-added records of the work detail table 380 are set to “Uncompleted”. On the other hand, in the case of modifying a shipment list, the work management unit 232 reflects the addition and deletion of the target items of the shipment list in the work detail table 380.

In a case where the user wants to deregister an existing shipment list, he or she selects the radio button 413 and designates a work ID or a transaction ID of the intended shipment list in the field 421 or 422. Then, the work management unit 232 extracts a list of target items of the corresponding work from the work detail table 380, and causes it to be displayed in the item list area 442. Then, when the user operates the OK button 451, the work management unit 232 changes the value of Status 377 of a corresponding record in the work table 370 to “Deregistered”, for example.

Note that the shipment list management screen 410 described using FIG. 10 is a mere example of a screen for managing work-related information and a list of target items. The management screen may have different screen configuration from the illustrated one. For example, a work list in a table form that is similar to the configuration of the work table 370 illustrated in FIG. 7 may be displayed on a screen, and a user may be allowed to select a work in the displayed list to transition therefrom to a management screen for the individual work.

### (2) Update of Work Status

In the present embodiment, the work management unit 232 performs status update regarding a work (pre-shipment confirmation or acceptance inspection) registered in the work table 370 only in a state where the user 20 has logged into the item management system 1 and a user operation representing a start of the work has been detected. The user operation (first user operation) herein may be any type of operation such as a GUI operation or a speech operation. Typically, the first user operation is detected on the application screen provided by the work management unit 232 to the user terminal 160 of the login user. That is, upon detecting that the first user operation has been performed by the login user at the user terminal 160, the work management unit 232 starts a status update session regarding a specific work. During this session, the work management unit 232 updates a status of a target item regarding the work to “Completed” when it is determined that the tag reader 100 has read the tag ID from the item tag 50 of the target item. The status update session may be terminated when status update for all of the target items has been completed, another user operation to instruct terminating the session has been detected, or a preset time length has elapsed. Examples of transition between application screens according to such embodiments will be described below.

Referring back to FIG. 9, the button 404 of the menu screen 400 is a button for calling an application screen (hereinafter, referred to as shipment screen) utilized when a user 20 performs the pre-shipment confirmation. The button 405 is a button for calling an application screen utilized when a user 20 performs acceptance inspection. Also when the button 404 or 405 is operated, the work management unit 232 may prompt the user 20 to input authentication information if he or she has not yet logged in, and perform user authentication based on the input authentication information. As the configuration of the application screen for the acceptance inspection may be similar to the configuration of the application screen for the pre-shipment confirmation, only the application screen for the pre-shipment confirmation will be described herein.

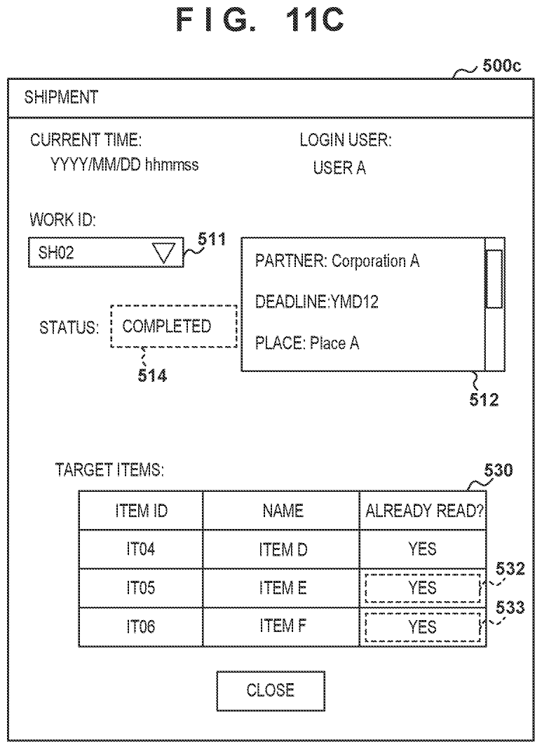

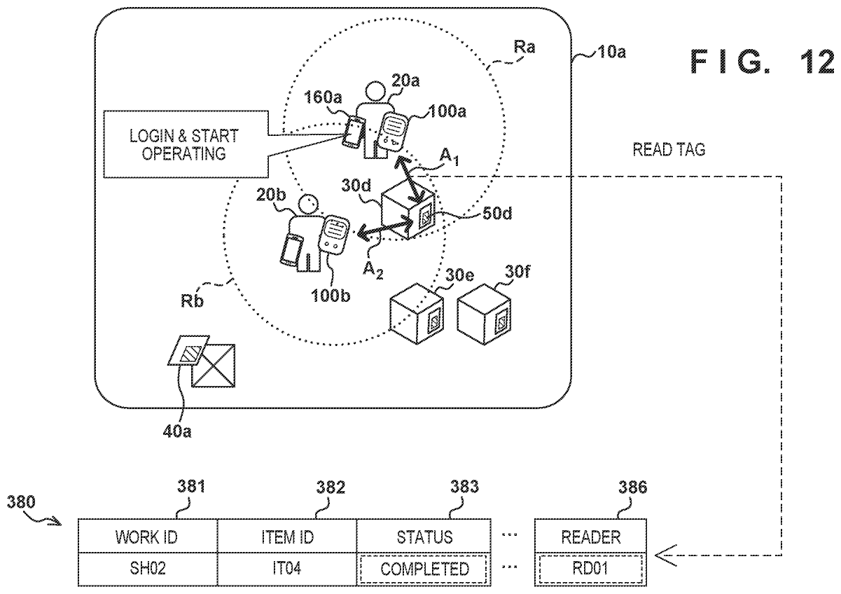

FIGS. 11A to 11C illustrate respective examples of the shipment screen provided for the pre-shipment confirmation. The shipment screen 500a illustrated in FIG. 11A includes a work ID field 511 and a related information display area 512, a start reading button 521, and an item list display area 530, for example. The work ID field 511 is a field for the login user to select a work ID of an intended work. Herein, it is assumed that the login user is the user 20a (whose name is “User A”). In the shipment screen 500a, the work ID field 511 provides selectable options of work IDs of works of which work type is “shipment” in the work table 370. The related information display area 512 is a display area for displaying work-related information for the selected work. The item list display area 530 is a display area for displaying a list of target items registered for the selected work.

In the example of FIG. 11A, the work ID “SH02” is selected in the work ID field 511, and information related to the corresponding work including the transaction partner, work deadline, and work place is displayed in the related information display area 512. The status of the selected work is displayed below the work ID field 511, and the status is “Uncompleted” here. The value of this work status corresponds to the value of Status 377 of the work table 370. In the item list display area 530, item IDs, names, and reading statuses of three target items registered in the work detail table 380 for the selected work are displayed. Herein, the target items are “Item D”, “Item E” and “Item F”, and none of the target items has not yet been read. The value of the reading status of each target item displayed in the item list display area 530 corresponds to the value of Status 383 of the work detail table 380 (for example, “Uncompleted” may correspond to “NO”, and “Completed” may correspond to “YES”).

The above-described first user operation that is a condition to update the status is herein an operation on the start reading button 521 (for example, a touch or a click) That is, when the start reading button 521 is operated on the shipment screen 500a, the work management unit 232 starts a session to update statuses based on results of tag reading for the target items displayed in the item list display area 530

After the start reading button 521 is operated, when the tag reader 100a used by the user 20a has read the tag ID from the item tag 50 of “Item D”, for example, the shipment screen 500a transitions to the shipment screen 500b illustrated in FIG. 11B. The shipment screen 500b has a similar configuration to the shipment screen 500a except that the start reading button 521 is changed into a stop reading button 522. As shown with a dashed box 531 in the figure, the reading status of “Item D” has been updated to “YES”. In addition, as shown with a dashed box 513, the work status has been updated to “In Progress”. The status “In Progress” means that the work has been started but there remains a target item for which tag reading has not yet been completed.

Furthermore, when the tag reader 100a used by the user 20a has read the tag IDs from the item tags 50 of “Item E” and “Item F”, the screen transitions to the shipment screen 500c illustrated in FIG. 11C. The shipment screen 500c has a similar configuration to the shipment screen 500b except that the stop reading button 522 has disappeared. As shown with dashed boxes 532 and 533 in the figure, the reading statuses of “Item E” and “Item F” have been updated to “YES”. In addition, as shown with a dashed box 514, the work status has been updated to “Completed”.

In this manner, the user 20 proceeds reading of tag IDs from item tags 50 of respective target items while the user 20 keeps in the login state and the status update session is ongoing. Then, upon finishing reading of tag IDs for all of the target items has finished, the work management unit 232 becomes aware that the work as a whole has been completed, and updates the value of Status 377 of the corresponding work record in the work table 370 to “Completed”.

### (3) Various Status Update Conditions

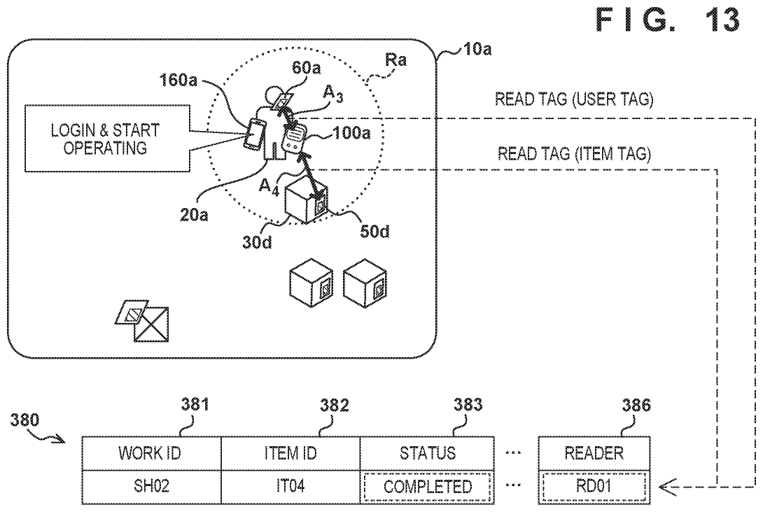

Update conditions for the work management unit 232 to update work-related statuses at least include that the user 20 has logged into the item management system 1 and has performed the user operation representing a start of the intended work at the user terminal 160 as described above. FIG. 12 is an explanatory diagram for explaining such a basic status update condition.

In the example of FIG. 12, there exist items 30d, 30e and 30f in the place 10a. It is assumed that the item 30d is a target item of pre-shipment confirmation. There are two users 20a and 20b who are active in the place 10a. The user 20a uses the user terminal 160a to access the management server 200, succeeds in login, and operates the start reading button 521 of the shipment screen 500a. A status update session for the pre-shipment confirmation in which the item 30d is a target item is thus started. As the item 30d is within the reading range Rₐ of the tag reader 100a carried by the user 20a, the tag reader 100a reads the tag ID from the item tag 50d of the item 30d (the arrow A₁ in the figure). The work management unit 232 can update the value of Status 383 of the record corresponding to the item 30d in the work detail table 380 to “Completed” based on this result of tag reading.

However, the item 30d is also within the reading range R_{b} of the tag reader 100b carried by the user 20b. Accordingly, there is possibility that the tag reader 100b reads the tag ID from the item tag 50d of the item 30d while the status update session is ongoing (the arrow A₂ in the figure). Depending on system requirements, the status may be allowed to be updated based on results of tag reading by such a tag reader used by a user other than the login user, or by a tag reader that is not associated with a specific user. If this is allowed, in a situation where multiple users are jointly involved in a work, it will be possible for all of the users using respective tag readers to efficiently proceed tag reading by just one user logging into the system and starting a status update session. In addition, by preparing a tag reader that is not associated with a specific user in a work site, it will also be possible for an arbitrary user who has logged into the system and started the status update session to carry out the work using that tag reader.

Conversely, the status may be prevented from being updated based on a result of tag reading by a tag reader that is not the login user's tag reader 100 in use by introducing an additional status update condition in addition to the above-described basic status update condition. In other words, the work management unit 232 may update a work-related status of a target item only when it is determined that a tag reader 100 used by the login user has read a tag ID from an item tag 50 of the target item.

For example, the work management unit 232 may determine that a login user is using a tag reader 100 in a case where reading result data indicating that the tag reader 100 has read a tag ID of a user tag 60 of the login user is received. FIG. 13 is an explanatory diagram for explaining such an additional status update condition.

In the example of FIG. 13, there exist a plurality of items 30 including the item 30d in the place 10a. It is assumed that the item 30d is a target item of pre-shipment confirmation. There is a user 20a who is active in the place 10a. The user 20a uses the user terminal 160a to access the management server 200, succeeds in login, and performs a predetermined user operation to start a status update session for pre-shipment confirmation. The tag reader 100a carried by the user 20a reads the tag ID from the user tag 60a (the arrow A₃ in the figure), and further reads the tag ID from the item tag 50d of the item 30d (the arrow A₄ in the figure). Based on these results of tag reading, the work management unit 232 determines that the tag reader 100a used by the user 20a who is the login user has read the tag ID from the item tag 50d of the item 30d which is a target item. Then, the work management unit 232 updates the value of Status 383 of the record corresponding to the item 30d in the work detail table 380 to “Completed”. Note that the work management unit 232 may update the status only in a case where a difference in reading time of the tag IDs read from the user tag 60 and the item tag 50 is smaller than a predetermined time threshold. Moreover, the work management unit 232 may update the status only in a case where a difference in reading position of the tag IDs read from the user tag 60 and the item tag 50 is smaller than a predetermined distance threshold.

In this manner, statuses of target items may be updated based only on results of tag reading in which a login user is involved so as to prevent an inconvenient situation where a tag reader that should be irrelevant to a work would cause a status update that is not intended by a user. This makes status updates even more reliable.

The work management unit 232 may determine which user 20 is using which tag reader 100 based on history of tag reading over multiple times instead of a single result of tag reading from a user tag 60. For example, assume that the tag reader 100a has detected the user tag 60a many times within a certain period in the past while the tag reader 100b has detected the user tag 60a only few times. In this case, the work management unit 232 determines that the user 20a is using the tag reader 100a based on the history of tag reading. The value of User 333 of the reader table 330 of FIG. 6A may be set based on such determination.

In an alteration example, an association between a tag reader 100 in the reader table 330 and a user 20 who uses the tag reader 100 may be given in advance without relying on reading of tag IDs from user tags 60. For example, in a case where the user 20a always uses the tag reader 100a, in order to associate the user 20a with the tag reader 100a, the user ID “U001” that identifies the user 20a is registered in the field of User 333 of the corresponding record in the reader table 330 in advance. The work management unit 232 may determine that the user 20a is using the tag reader 100a based on this user ID in User 333.

In another alteration example, the work management unit 232 may determine that a user 20 is using a tag reader 100 based on that the user terminal 160 used by the user 20 for the login has a communication connection with the tag reader 100. For example, the user terminal 160a establishes a local communication connection with the tag reader 100a via the connection unit 164. When the user 20a has logged into the item management system 1 using the user terminal 160a, the control unit 161 of the user terminal 160a transmits the reader ID of the tag reader 100a obtained through the communication connection with the tag reader 100a to the management server 200. The work management unit 232 can determine that the user 20a who is the login user is using the tag reader 100a by receiving this reader ID.

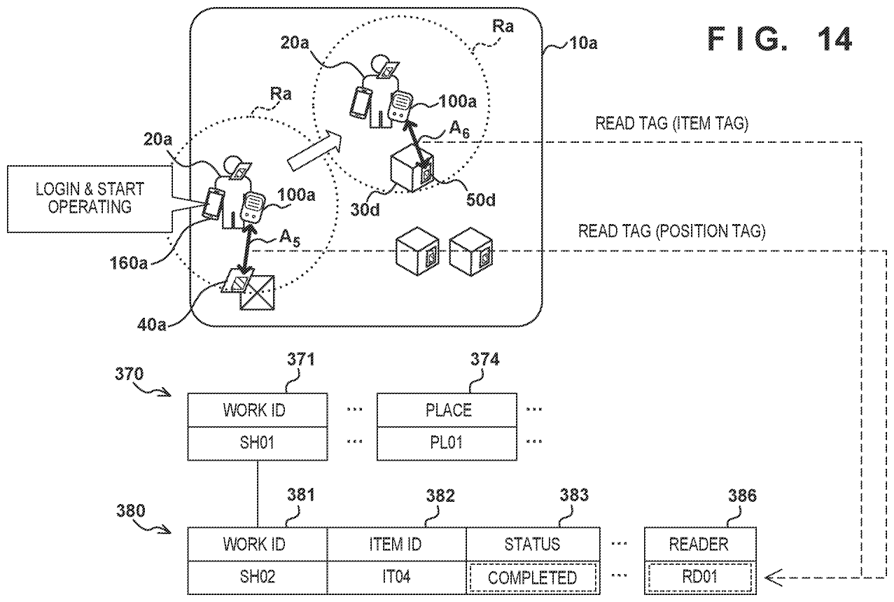

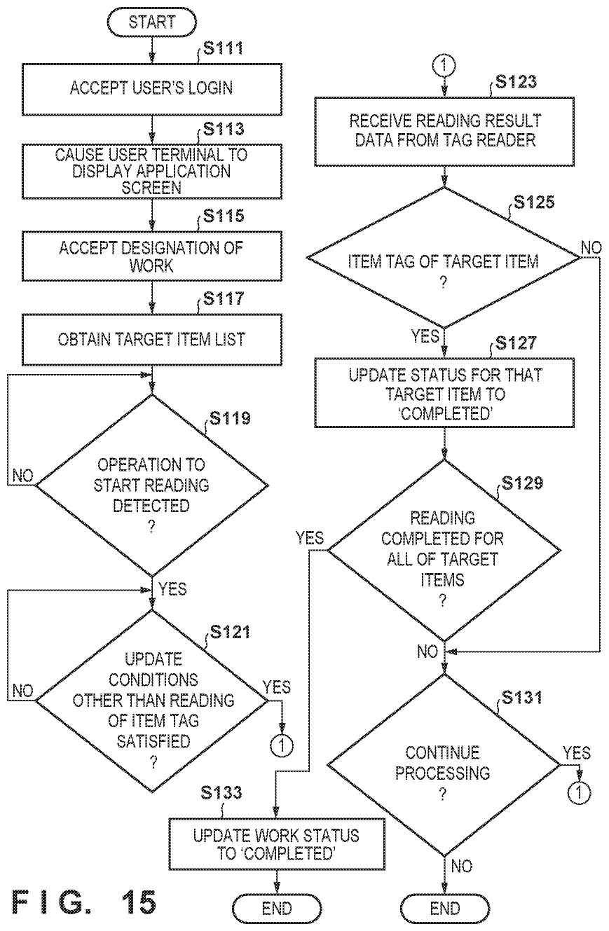

An additional status update condition may include that the tag reader 100 has read a tag ID from a position tag 40 of the place 10 in which the work is scheduled to be done. FIG. 14 is an explanatory diagram for explaining such an additional status update condition.

In the example of FIG. 14, again, there exist a plurality of items 30 including the item 30d in the place 10a. It is assumed that the item 30d is a target item of pre-shipment confirmation. In addition, it is assumed that the place 10a is a workplace that is registered in advance in the work table 370 for the pre-shipment confirmation that the user 20a is going to carry out. The user 20a uses the user terminal 160a to access the management server 200, succeeds in login, and performs a predetermined user operation to start a status update session for pre-shipment confirmation. The tag reader 100a carried by the user 20a reads the tag ID associated with the place ID “PL01” of the place 10a from the position tag 40a installed in the place 10a (the arrow A₅ in the figure). Further, after the user 20a moves, the tag reader 100a reads the tag ID from the item tag 50d of the item 30d (the arrow A₆ in the figure). The work management unit 232 determines that the status update conditions are satisfied based on these results of tag reading, and updates the value of Status 383 of the record corresponding to the item 30d in the work detail table 380 to “Completed”. According to such a status update condition, even if a status update session has been accidentally started in a place where the work is not scheduled to be done, the statuses of respective target items regarding the work can be prevented from being updated as a result. Hence, reliability of status updates can be much more enhanced.

An additional status update condition may include that a second user operation is detected at the tag reader 100. As an example, the second user operation is assumed to be pressing a button of the operation unit 115 of the tag reader 100. In this example, the work management unit 232 may update a work-related status of a target item only when the tag ID of the item tag 50 of the target item has been read in a state where the user 20 is pressing the button on the tag reader 100. Alternatively, the work management unit 232 may update the work-related status of the target item only when the tag ID has been read during a period from the button on the tag reader 100 being pressed by the user 20 to a time when a certain time length elapses or when the button is pressed again. The control unit 111 of the tag reader 100 may include a flag (or an indication in an arbitrary format) indicating that the second user operation has been detected in reading result data and transmits it to the management server 200, for example. In this manner, the work management unit 232 can promptly obtain the reading result data to which the flag is added from the reading result table 350 to efficiently determine whether to update a status for each target item.

Though numerous examples of status update conditions have been described in this section, the described conditions may be combined in any way with each other. For example, in addition to the basic status update condition, two or more of reading of a user tag 60 of a login user, reading of a position tag 40, and detection of the second user operation may be adopted as the status update conditions.

### 5. FLOW OF PROCESSING

FIG. 15 is a flowchart illustrating an example of a flow of status update processing that may be performed by the management server 200 in the present embodiment. This status update processing may be started when the user 20 calls the application screen for pre-shipment confirmation or acceptance inspection at the user terminal 160, for example. Note that, before starting the status update processing, it is assumed that some works and their lists of target items have already been registered in the work table 370 and the work detail table 380. In the following descriptions, a process step is abbreviated as S (step).

First, in S111, the work management unit 232 accepts a login by a user 20 to the item management system 1. The work management unit 232 may perform user authentication (login authentication) based on authentication information input by the user 20 on the screen of the user terminal 160, for example. Herein, it is assumed that the authentication is successful and the user 20 enters a login state in the item management system 1.

Next, in S113, the work management unit 232 causes the user terminal 160 of the user 20 who is the login user to display the application screen regarding a work. For example, if the work indented by the user 20 is pre-shipment confirmation, the shipment screen 500a illustrated in FIG. 11A may be displayed by the display unit 166 of the user terminal 160.

Next, in S115, the work management unit 232 accepts designation of a work from the user 20 on the displayed screen. For example, the user 20 designates one of uncompleted (or ongoing but suspended) works from among works registered in advance.

Next, in S117, the work management unit 232 obtains data regarding the work designated by the user 20 from the work table 370, and a list of one or more target items from the work detail table 380.

Next, in S119, the work management unit 232 waits for detection of the first user operation representing a start of the work of tag reading for status update. When a notification that the first user operation has been detected is received from the user terminal 160, the processing proceeds to S121. At this point, the work management unit 232 may update the value of Status 377 of the work table 370 for the work designated in S115 to “In Progress”.

In S121, the work management unit 232 determines whether the status update conditions other than reading of tag IDs from item tags 50 of target items are satisfied. The status update conditions herein includes one or more of the followings, for example:
1) reading of the tag ID from the user tag 60 of the login user;
2) detection of the second user operation at the tag reader 100; and
3) reading of the tag ID from the position tag 40 installed in the work place.
   When it is determined that the required conditions are satisfied, the processing proceeds to S123. In a case where it is determined that any of the conditions is not satisfied, the work management unit 232 may cause the user terminal 160 to display a message for prompting to perform a corresponding action (for example, “read the user tag”, “press the button of the tag reader”, and so on).

In S123, the communication unit 210 receives reading result data from the tag reader 100. In a practical example, the tag reader 100 from which the reading result data is received herein is the tag reader 100 that is determined to be used by the login user. In another practical example, the tag reader 100 from which the reading result data is received herein is an arbitrary tag reader 100. The tag processing unit 231 adds reading result records corresponding to the received reading result data to the reading result table 350.

The subsequent processing branches in S125 depending on whether there are any tag IDs indicated by the reading result data which are tag IDs of item tags 50 of the target items included in the list obtained in S117. In a case where there are any tag IDs of item tags 50 of the target items, the processing proceeds to S127. Otherwise, the processing proceeds to S131.

In S127, the work management unit 232 updates the value of Status 383 of the work detail table 380 for the target item to “Completed” as it is determined that the tag ID have been read from the item tag 50 of the target item in a state where the status update conditions are satisfied.

Next, in S129, the work management unit 232 determines whether tag reading has been completed for all of the target items of the work in progress or not. In a case where tag reading has been completed for all of the target items, the processing proceeds to S133. Meanwhile, in a case where there remains a target item for which tag reading has not been completed, the processing proceeds to S131.

In S131 the work management unit 232 determines whether to continue the status update processing or not. For example, in a case where a user operation for instructing to stop the work has been detected at the user terminal 160 (for example, operation of the button 522 of the shipment screen 500b in FIG. 11B), the work management unit 232 determines to terminate the status update processing. In a case where the work management unit 232 determines to continue the status update processing, it goes back to waiting for reading result data in S123.

In a case where tag reading has been completed for all of the target items, the work management unit 232 updates the value of Status 377 of the work table 370 for the work designated in S115 to “Completed”. Then, the status update processing of illustrated in FIG. 15 ends.

### 6. CONCLUSION

Various embodiments, practical examples and alteration examples of the technology according to the present disclosure have been described in detail with reference to FIGS. 1 to 15. According to the above-described embodiments, a list of one or more items that are subject to a work by a user and a status of each item regarding the work are managed in a database in an item management system. A wireless device that stores identification information is attached to each item. A reading apparatus attempts to read identification information from wireless devices. Then, the status of a first item regarding the work is updated when it is determined that first identification information has been read from a first wireless device attached to the first item included in the list in a state where a user has logged into the system and a user operation representing a start of the work has been detected. With this configuration, it is possible to easily discern a reading result obtained at a timing intended by a user who is in charge of the work from among a large number of tag reading results accumulated over time in the system and to appropriately update the status of each item regarding the work. This enhances reliability of updating item management statuses based on results of tag reading. In a case where the user operation representing a start of the work is detected on an application screen provided to a user terminal, the user does not need to individually turn on and off the reading apparatus each time he or she conducts the work. Therefore, cumbersome operations are reduced and a risk of mistake that a tag reader is kept in off-state at a timing when it should be active can be eliminated as well.

According to the above-described embodiments, update conditions to update statuses regarding the work include that the reading apparatus used by the user who has logged into the system has read the first identification information from the first wireless device. In this case, it is possible to prevent an inconvenient situation where a reading apparatus that should be irrelevant to the work would cause a status update that is not intended by the user. This can make status updates even more reliable. According to a practical embodiment, users carry respective second wireless devices, and which reading apparatus the login user is using may be determined based on a result of reading the second identification information from the second wireless device carried by the login user. With this configuration, as associations between users and reading apparatuses are dynamically determined based on results of reading the second identification information, the reading apparatuses can be flexibly treated by a plurality of users (for example, each user is not forced to use a specific reading apparatus). According to an alteration example, when a reading apparatus is associated with the login user in advance in the database, it may be determined that the login user is using the reading apparatus. In this case, each user does not need to carry the second wireless device. According to another alteration example, it may be determined that the login user is using the reading apparatus based on that a terminal apparatus the login user is using has a communication connection with the reading apparatus. In this case as well, each user does not need to carry the second wireless device and, in addition, each user can also use a different reading apparatus for each work.

According to the above-described embodiments, the update conditions may include that the reading apparatus has read the first identification information from the first wireless device in a state where a further user operation has been detected at the reading apparatus. In this case, the reading apparatus can give an indication such as a flag to a reading result that should trigger a status update from among reading results that are accumulated over time, which makes updates to work-related statuses even more efficient.

According to the above-described embodiments, the update conditions may include that third identification information has been read from a third wireless device installed in a place where the work is performed. In this case, even if a user operation representing a start of the work has been accidentally performed in a place where the work is not scheduled to be done, the statuses can be prevented from being undesirably updated as a result.

According to the above-described embodiments, each wireless device is an RFID tag, and the reading apparatus reads information sent back from the RFID tag utilizing energy of electromagnetic waves emitted to a reading range. In this case, a wireless device attached to each item does not need a battery and a complicated transceiver mounted thereon, and the mechanism according to the above-described embodiments can be introduced with low cost even in a situation where there are a large number of items under management of the item management system.

### 7. OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to the present invention, reliability of updating item management statuses based on results of tag reading will be enhanced.

1. An item management system comprising:
a reading apparatus capable of reading, from a wireless device, identification information stored in the wireless device;
a management unit configured to manage, in a database, a list of one or more items that are subject to a work by a user and a status of each item regarding the work; and
a first wireless device attached to a first item included in the list and storing first identification information associated with the first item,
wherein the management unit is configured to update the status of the first item when it is determined that the reading apparatus has read the first identification information from the first wireless device in a state where a first user has logged into the item management system and a first user operation representing a start of the work regarding the list has been detected.

2. The item management system according to claim 1, wherein the management unit is configured to update the status of the first item when it is determined that the first user is using the reading apparatus and the reading apparatus has read the first identification information from the first wireless device in the state where the first user has logged into the item management system and the first user operation representing a start of the work regarding the list has been detected.

3. The item management system according to claim 1, wherein the item management system further comprises:
a second wireless device carried by the first user and storing second identification information associated with the first user,
wherein the management unit is configured to determine that the first user is using the reading apparatus based on a reading result indicating that the reading apparatus has read the second identification information from the second wireless device.

4. The item management system according to claim 1, wherein the management unit is configured to provide a user terminal of the first user who has logged into the item management system with an application screen related to the work, and
the first user operation is detected on the application screen.

5. The item management system according to claim 1, wherein the management unit is configured to update the status of the first item when it is determined that a second user operation has been detected on the reading apparatus and that the reading apparatus has read the first identification information from the first wireless device.

6. The item management system according to claim 1, wherein the item management system further comprises:
a third wireless device installed in a place where the work is performed and storing third identification information associated with the place,
wherein the management unit is configured to update the status of the first item when it is determined that the reading apparatus has read the first identification information from the first wireless device and the reading apparatus has read the third identification information from the third wireless device.

7. The item management system according to claim 2, wherein the management unit is configured to determine that the first user is using the reading apparatus when the reading apparatus is associated with the first user in advance in the database.

8. The item management system according to claim 2, wherein the management unit is configured to determine that the first user is using the reading apparatus based on that a terminal apparatus the first user is using for the login has a communication connection with the reading apparatus.

9. The item management system according to claim 1, wherein the work is a work related to shipment or arrival of the one or more items, and
the status represents whether existence of each item has been confirmed in the work or not.

10. The item management system according to claim 1, wherein the wireless devices are radio frequency identification (RFID) tags, and
the reading apparatus is configured to emit an electromagnetic wave to a reading range and read information sent back from the wireless device utilizing energy of the electromagnetic wave.

11. A method of updating a status of an item in an item management system, comprising:
maintaining, in a database, a list of one or more items that are subject to a work by a user and the status of each item regarding the work;
accepting login of a first user to the item management system;
detecting a first user operation representing a start of the work regarding the list;
attempting to read identification information from a wireless device attached to the one or more items included in the list by a reading apparatus that is capable of reading, from a wireless device, identification information stored in the wireless device; and
updating the status of a first item when it is determined that the reading apparatus has read first identification information associated with the first item from a first wireless device attached to the first item out of the one or more items.

12. An information processing apparatus that operates in an item management system, comprising:
a communication unit configured to communicate with a reading apparatus capable of reading, from a wireless device, identification information stored in the wireless device; and
a management unit configured to manage, in a database, a list of one or more items that are subject to a work by a user and a status of each item regarding the work;
wherein, when it is determined that the reading apparatus has read first identification information from a first wireless device attached to a first item included in the list and storing the first identification information associated with the first item in a state where a first user has logged into the item management system and a first user operation representing a start of the work regarding the list has been detected, the management unit is configured to update the status of the first item.
